(19) United States
(12) Patent Application Publication
(10) Pub. No.: US 2026/0364934 A1
(43) Pub. Date: Nov. 19, 2026

(54) PARTICLE ADHESION TO COMPOSITE STRUCTURES

(71) Applicant: SUPERNAL, LLC, WASHINGTON, DC (US)

(72) Inventor: Jesse Stohlman Rivera, Long Beach, CA (US)

(21) Appl. No.: 19/135,764

(22) PCT Filed: Dec. 8, 2023
(86) PCT No.: PCT/US2023/083171

§ 371 Date: Jun. 4, 2025

Related U.S. Application Data
(60) Provisional application No. 63/431,452, filed on Dec. 9, 2022.

(51) Int. Cl. B32B 37/14; B32B 27/08; B32B 27/12; B32B 27/20; B32B 33/00; B32B 37/06; B32B 37/24

(52) U.S. Cl. CPC B32B 37/142; B32B 27/08; B32B 27/12; B32B 27/20; B32B 33/00; B32B 37/06; B32B 37/24; B32B 2037/243; B32B 2305/22; B32B 2305/72; B32B 2605/18

(57) ABSTRACT

A vehicle part includes a composite laminate. The vehicle part also includes a substrate coupled to an outer surface of the composite laminate. The vehicle part further includes a coating. The coating is thermally applied to the substrate. The substrate promotes bonding between the thermally applied coating and the substrate.

### CROSS-REFERENCE TO RELATED APPLICATION

This application claims priority to U.S. Provisional Patent Application No. 63/431,452, filed Dec. 9, 2022, the entire contents of which are hereby incorporated by reference.

### BACKGROUND

Mechanical structures or parts (such as structures or parts used on aircrafts or automobiles) are often sprayed with coatings to protect the structure or part, including from the effects of erosion and to prolong the life of the structure or part. These coatings often utilize various combinations of materials, specific to the needs of the part or application, exhibiting favorable corrosion or erosion resistant properties, and are applied using a variety of known processes. Thermal spraying is one such application process in which the protective materials are exposed to high heat and velocity while being sprayed at the part.

The high heat melts the materials en route which then impinge onto the surface of the part and solidify, forming a protective layer.

As a person of ordinary skill in the art will understand, bond strength (or adhesive capability) of the protective coating to the part can vary significantly based on the respective material properties of the coating and the part. Spraying of certain erosion and corrosion protective coatings having desirable characteristics may result in a weak bond strength with some part. As a result of a weak bond strength, the protective coatings may prematurely detach from the part in operation.

Accordingly, the present invention seeks to promote adhesion of particles, such as erosion protective materials applied onto composite parts.

### SUMMARY

In a first example embodiment, a vehicle part is provided. The vehicle part includes a composite laminate, a substrate coupled to an outer surface of the composite laminate, and a coating. The coating being thermally applied to the substrate. The substrate promotes bonding between the thermally applied coating and the substrate.

In various embodiments, the substrate is a composite including a plurality of particles that include at least one particle material, where the plurality of particles promote bonding between the thermally applied coating and the substrate. The composite also includes a resin, and a fiber impregnated with the resin.

In various embodiments, the fiber of the substrate is coated with the plurality of particles.

In various embodiments, the plurality of particles are disposed within the resin of the substrate.

In various embodiments, the fiber impregnated with resin is a first fiber and the composite laminate includes a second fiber different than the first fiber.

In various embodiments, the substrate includes a resin, and a plurality of particles. The plurality of particles include at least one particle material, where the plurality of particles promote bonding between the thermally applied coating and the substrate.

In various embodiments, the plurality of particles are randomly disposed throughout the resin.

In various embodiments, at least 50% of the plurality of particles are disposed on a surface of the substrate that includes the thermally applied coating.

In various embodiments, the resin is a thermoplastic.

In various embodiments, the resin is a thermoset.

In various embodiments, a type of resin used in the composite laminate is the same as the resin of the substrate.

In various embodiments, the substrate is co-cured with the composite laminate and forms an outer ply along a portion of the composite laminate.

In various embodiments, the plurality of particles include a first particle material and a second particle material different than the first particle material.

In various embodiments, a particle material of the coating is the same as the at least one particle material of the plurality of particles of the substrate.

In various embodiments, the coating is thermally coupled to at least one of the plurality of particles of the substrate.

In various embodiments, the vehicle part is a rotor blade.

In various embodiments, the coating is thermally applied between a 0 and 25 percent chord length from a leading edge of the rotor blade.

In a second example embodiment, a method for bonding a coating onto a composite laminate structure is provided. The method includes preparing a substrate for bonding onto an uncured composite laminate. The substrate includes a resin material and a plurality of particles, where the plurality of particles form anchoring points for deposition of a coating. The method also includes co-curing the substrate and the composite laminate such that the substrate is disposed on a portion of an outer surface of the composite laminate. The method further includes determining, for a coating, at least one of a deposition type, a deposition temperature, a deposition velocity, and at least one deposition material for the coating. The method additionally includes depositing, using thermal spraying, the coating onto a surface of the substrate such that the at least one deposition material is coupled with the at least one particle material of the substrate.

In various embodiments, preparing the substrate for bonding onto the uncured composite laminate further includes determining an amount and a type of at least one of a resin material, a fiber material, and at least one particle material. When determining the resin material the determination is based on a material property of a resin material used in the composite laminate, and where when determining the at least one particle material, the determination is based on bonding properties of the at least one particle material with the at least one deposition material for the coating.

In various embodiments, preparing the substrate for bonding onto the uncured composite laminate further includes distributing, randomly, the plurality of particles throughout the resin to form a particle impregnated resin; impregnating the fiber material with the particle impregnated resin to form a particle impregnated ply; and engaging a surface of the particle impregnated ply with a surface of the uncured composite laminate.

In various embodiments, the substrate further includes a plurality of fibers, the fibers being coated with the plurality of particles to form particle coated fibers.

In various embodiments, the particle coated fibers are impregnated with the resin material.

In various embodiments, the substrate is a particle impregnated prepreg fiber sheet, where the plurality of particles are coated onto the fiber.

In various embodiments, the substrate is a particle impregnated prepreg fiber sheet, where the plurality of particles are randomly distributed throughout the resin.

In various embodiments, the composite laminate structure is a rotor blade, and depositing the coating onto the surface of the substrate includes thermally spraying the coating between a 0 and 25 percent chord length from a leading edge of the rotor blade.

In a third example embodiment, a method for bonding a coating onto a composite laminate structure is provided. The method includes preparing a substrate for bonding onto a cured composite laminate. The substrate includes a resin material and a plurality of particles, where the plurality of particles form anchoring points for deposition of a coating. The method also includes applying the prepared substrate onto an outer surface of the cured composite laminate. The method further includes curing the prepared substrate onto the outer surface of the cured composite laminate. The method additionally includes determining, for a coating, at least one of a deposition type, a deposition temperature, a deposition velocity, and at least one deposition material for the coating. The method also includes depositing, using thermal spraying, the coating onto a surface of the substrate such that the at least one deposition material is coupled with the at least one particle material of the substrate.

In various embodiments, preparing the substrate for bonding onto the cured composite laminate further includes determining an amount and a type of at least one of a resin material, a fiber material, and at least one particle material, where when determining the at least one particle material, the determination is based on bonding properties of the at least one particle material with the at least one deposition material for the coating.

In various embodiments, preparing the substrate for bonding onto the cured composite laminate further includes distributing, randomly, the plurality of particles throughout the resin to form a particle impregnated resin; impregnating the fiber material with the particle impregnated resin to form a particle impregnated ply; and engaging a surface of the particle impregnated ply with a surface of the cured composite laminate.

In various embodiments, the substrate further includes a plurality of fibers, the fibers being coated with the plurality of particles to form particle coated fibers.

In various embodiments, the particle coated fibers are impregnated with the resin material.

In various embodiments, the substrate is a particle impregnated prepreg fiber sheet, where the plurality of particles are coated onto the fiber.

In various embodiments, the substrate is a particle impregnated prepreg fiber sheet, where the plurality of particles are randomly distributed throughout the resin.

In various embodiments, the composite laminate structure is a rotor blade, and depositing the coating onto the surface of the substrate includes thermally spraying the coating between a 0 and 25 percent chord length from a leading edge of the rotor blade.

These as well as other aspects, advantages, and alternatives will become apparent to those of ordinary skill in the art by reading the following detailed description, with reference, where appropriate, to the accompanying drawings

### BRIEF DESCRIPTION OF THE DRAWINGS

FIG. 1 is a perspective view of a rotor, according to an example embodiment of the present invention.

FIG. 2 is a cross-sectional view of a vehicle part, including a coated fiber layer, according to an example embodiment of the present invention.

FIG. 3 is a cross-sectional view of a vehicle part, including a particle impregnated prepreg, according to an example embodiment of the present invention.

FIG. 4A is a cross-sectional view of a vehicle part, including a particle embedded surface, according to an example embodiment of the present invention.

FIGS. 4B-4C are exploded cross-sectional views of the example embodiment of FIG. 4A.

FIG. 5 is a block diagram illustrating a method for bonding a coating onto a composite laminate structure, according to an example embodiment of the present invention.

FIG. 6 is a block diagram illustrating another method for bonding a coating onto a composite laminate structure, according to an example embodiment of the present invention.

### DETAILED DESCRIPTION

Disclosed herein are examples describing various features and functions of the disclosed apparatus, processes, and methods with reference to the accompanying figures. The figures are not necessarily to scale and sizes of the various elements may be distorted for clarity. It is understood that various aspects of the disclosed apparatus, processes, and methods can be arranged and combined in a wide variety of different configurations, all of which are contemplated herein. The disclosure generally relates to promoting adhesion and bond strength of particles to a composite laminate.

The present application is directed to processes, techniques, and materials for promoting adhesion of particles or materials (e.g., an erosion protection material) to a structure, such as a leading edge of a rotor blade. In some embodiments, the rotor blade may be part of a vehicle. In some embodiments, the vehicle may be a VTOL, which may or may not use propellers to hover, takeoff, and/or land. It should be understood that in other embodiments, the vehicle may be any other type of vehicle that may be able to utilize the advantages of the present invention, such as a ground vehicle (i.e., an automobile), a sea vehicle (such as a boat), or a flying craft (such as an aerial, floating, soaring, hovering, airborne, aeronautical aircraft, airplane, plane, spacecraft, a helicopter, an airship, or an unmanned aerial vehicle, or a drone).

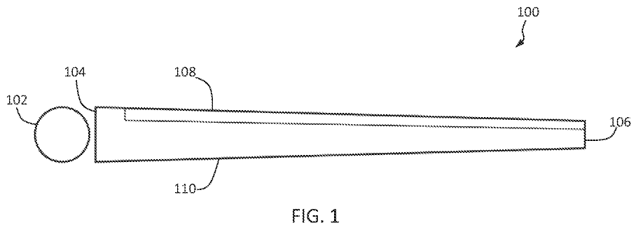

In some embodiments, the vehicle may include one or more propellers used to drive the vehicle. The one or more propellers may each comprise a plurality of rotor blades, such as rotor blade 100 described below with respect to FIG. 1. The rotor blade 100 may comprise a composite laminate, and may or may not have a cross-sectional airfoil shape. Each propeller may be configured, for example, as tiltrotors, lift rotors, or any other type of rotors. In other embodiments, the vehicle may include one or more turbine engines, one or more tires, one or more ski-structures, or the like instead of the one or more propellers used to drive the vehicle.

FIG. 1 shows an example rotor blade 100 on which the material of the present application may be applied. The rotor blade 100 may include a root 104 attached to a rotor hub 102, a tip 106 opposite the root 104, a leading edge 108, and a trailing edge 110 opposite the leading edge 108. The rotor blade 100 may rotate clockwise or counterclockwise about the rotor hub 102. The rotor blade 100 may comprise any suitable material, for example a composite laminate, and may vary in cross-section thickness from the leading edge 108 to the trailing edge 110, and/or vary in thickness along a length spanning from the root 104 to the tip 106.

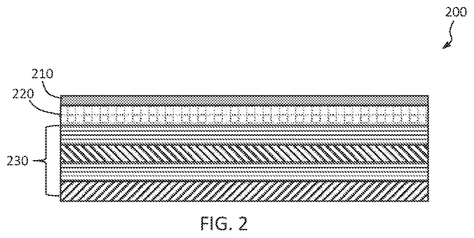

FIG. 2 is a cross-sectional view of a vehicle part 200, including a plurality of layers, according to an example embodiment of the present invention. As illustrated, the vehicle part 200 may comprise a composite laminate 230, a coated fiber layer 220, and a coating 210. In some embodiments, the vehicle part may be a rotor blade, such as rotor blade 100 shown in FIG. 1. However, it is to be understood that the vehicle part 200 may be other structural or non-structural parts. For example, vehicle part 200 may be a fairing, a flap, an elevator, a wing skin, a body member, etc.

The composite laminate 230 in the example embodiment is a structural member of the rotor blade and is designed to carry load throughout the rotor blade. The composite laminate 230 may have an airfoil cross-sectional shape and act as a lift or thrust producing surface. In other examples the composite laminate 230 may take on other cross-sectional shapes, such as a nacelle or an aerodynamic fitting for an aircraft body.

As a person of ordinary skill in the art will recognize, the composite laminate 230 may include multiple types of fibers (aramid, carbon, glass, etc.), weave or no weave patterns (chopped, unidirectional, plain weave, 2×2 twill weave, 4×4 twill weave, 5 harness, 8 harness, etc.), matrices (metal matrix; thermoplastic and thermoset polymer matrix, e.g., epoxies), etc. The composite laminate 230 may further vary in the number of plies used, the specific ratio of fiber to matrix, and the orientation of the respective plies.

In the example embodiment shown, the coated fiber layer 220 mates to an outer surface of the composite laminate 230. The coated fiber layer 220 acts, at least as, an attachment, bonding, or anchoring point for coating 210. In some examples, the coating 210 may be mechanically bonded, physically bonded, and/or chemically bonded to the coated fiber layer 220. The coated fiber layer 220 may conform to all, or a region, of the shape and design of the composite laminate 230. While FIG. 2 illustrates the coated fiber layer 220 situated above the composite laminate 230, it is to be understood that the coated fiber layer 220 may be located on any surface of the composite laminate 230. For example, in rotor blades having a cross-sectional airfoil shape, the coated fiber layer 220 may be located on a leading edge, a trailing edge, an upper camber (upper surface), and/or a lower camber (lower surface). The coated fiber layer 220 may cover the entire outer surface area of the composite laminate 230, or it may only cover a portion of the outer surface area of the composite laminate 230. For example, the amount of surface area of the composite laminate 230 covered by the coated fiber layer 220 may be any range known to those skilled in the art, as suitable for the application. Further, the coated fiber layer 220 may be located along select portions of the composite laminate 230. For example, in a composite laminate rotor blade the coated fiber layer 220 may cover the leading edge and the first 25 percent chord length of the upper surface. The coated fiber layer 220 may span the longitudinal length of composite laminate 230, for example from root to tip of the rotor blade. However, in other examples the coated fiber layer 220 may lie along only a portion of the longitudinal length of composite laminate 230.

In some embodiments, the coated fiber layer 220 may be cured, as a surface ply or series of plies, to the composite laminate 230 during initial layup. In such an embodiment, during manufacturing of the vehicle part 200 the composite laminate 230 will include a surface ply, or series of plies, of the coated fiber layer 220; the entire ply stack-up may then be cured so that the surface ply of the stack-up is at least the coated fiber layer 220. One skilled in the art would understand the various methods of composite layup that may be used in manufacturing structural and non-structural composite parts.

In other embodiments, however, the composite laminate 230 may be retrofitted with the coated fiber layer 220 bonded on the surface. The resin/matrix used to bond the coated fiber layer 220 to the composite laminate layer 230 may be the same or a similar resin/matrix used in the composite laminate 230. The resin/matrix used to bond the coated fiber layer 220 to the composite laminate layer may further include particles, for example metallic and/or ceramic particles, to better allow adhesion of the coating 210. In some embodiments, the coated fiber layer 220 may be cured onto the composite laminate 230 at room temperature and standard atmospheric pressure. While in other embodiments the curing may involve an autoclave, or a heat blanket, and/or vacuum bagging.

Once cured onto the composite laminate 230, the surface of the coated fiber layer 220 may be prepped to further promote adhesion of the coating 210. In some embodiments the surface of the coated fiber layer 220 will not require any treatments prior to application of the coating 210. Determination of the surface treatment to be employed in prepping the coated fiber layer 220 may vary based on the coating 210 to be applied.

The coated fiber layer 220 may be made from any type of suitable fiber and weave pattern and may incorporate any type of suitable metallic, ceramic, or metallic-ceramic coating. The coated fiber layer 220 may be a continuously coated fiber layer in some embodiments; however, it may also be individually coated fibers or tows. In some embodiments the coated fiber layer 220 may be a plurality of fibers arranged in a random or non-discernable orientation subsequently coated with a continuous metallic layer, for example VeeloVEIL™M. While in other embodiments the fiber orientation may not be random and/or the fibers may be coated prior to forming a weave. For example, and in no way meant to limit the scope of the invention, the coated fiber layer 220 may comprise randomly arranged carbon fiber strands subsequently coated in a metal or metal alloy. The coated fiber layer 220 may act as a non-structural unit, or it may be structural and designed to transfer loading along with the composite laminate 230. The materials chosen for the coated fiber layer 220 may be based, at least in part, on bonding capabilities with the coating 210. In some embodiments the coated fiber layer 220 chosen may be based, at least in part, on other properties, for example lightning strike protective properties.

While the coating 210, in the example embodiment shown, is a metallic erosion protective coating, other types of coatings, for example corrosion protective coatings, may be contemplated. The coating 210 may be made from a single metal or metal alloy, a plurality of metals or metal alloys, a single ceramic material, a combination of ceramic materials, and/or a combination of single or multiple ceramic materials and single or multiple metals including metal alloys. For example the coating 210 may comprise aluminum, aluminum alloys, tungsten, tungsten alloys, cobalt, cobalt alloys, nickel, nickel alloys, chrome, chrome alloys, molybdenum, molybdenum alloys, iron, iron alloys, zinc, zinc alloys, combinations of metals and/or metal alloys, carbides combined with metals and/or metal alloys, nickel-chromium-aluminum, chromium-oxide, alumina-titania, aluminum-oxide, chromium-carbide, tungsten-carbide, tungsten-carbide-nickel, etc. A person having ordinary skill in the art would recognize the various types of coatings that may be used or contemplated.

The coating 210 may have a constant thickness along a cross-section of the vehicle part 200, or it may vary in thickness along the cross-section of the vehicle part 200.

Further, the coating 210 may have a constant thickness, or it may vary in thickness, along a longitudinal length of the vehicle part 200, such as a length spanning from a root of a rotor blade to a tip of the rotor blade. In some embodiments the thickness of the coating 210 on the vehicle part 200 may range between 10-100 μm, 100-500 μm, 500-1,000 μm, 1,000-5,000 μm.

While application of the coating 210, as shown in the example embodiment, is performed using a thermal spraying process, other methods and processes of application may be used. Thermal spraying of the coating 210 may be performed using high-velocity oxygen fuel (HVOF), high-velocity air fuel (HVAF), air plasma spraying, combustion wire and powder spraying, twin wire arc spraying, spray and fuse hardening, cold gas dynamic spraying (CGDS), etc.

The temperature of thermal spraying can vary based on the coating material sprayed and the spraying process. For example, the HVAF process may spray at a temperature of about 1900-1950 degrees Celsius, whereas the HVOF process may spray at a much higher temperature, such as about 1000 degrees Celsius greater than the HVAF process. Further, the temperature, particle velocity, and particle materials used by the process may affect the bond strength (bondability) and crack resistance of the coating.

Spraying at a temperature closer to a particle material melting point, rather than a particle material boiling point, may reduce cracking of the coating and may further mitigate negative structural effects occurring in the part being sprayed as a result of higher spray temperatures. Structural parts, for example composites, coated by a thermal spraying process may be susceptible to structural damage above certain spray temperature ranges and, thus, may benefit from employing a lower spray temperature in coating the composite part.

After the coating 210 is applied to the coated fiber layer 220 of the vehicle part 200, surface preparation may be performed. For example, the coating 210 may need to be polished or buffed to increase surface smoothness and remove burrs or other rough features present on the surface. However, in some embodiments only a portion of surface coating 210 may need to be polished or buffed. For example on a rotor blade, the coating on the leading edge portion and 0-25 percent chord length may be polished or buffed to allow for laminar flow, while the coating 210 greater than the 25 percent chord length may be left un-polished, or alternatively may be further abraded, to promote turbulent flow by tripping the boundary layer.

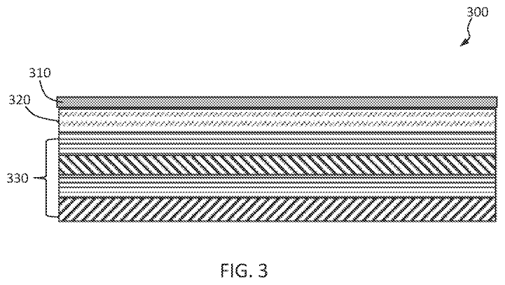

FIG. 3 is a cross-sectional view of a vehicle part 300, including a particle impregnated prepreg, according to an example embodiment of the present invention. The vehicle part 300 in the example embodiment may be any structural or non-structural composite laminate based part, for example a rotor blade, such as rotor blade 100. As illustrated, the vehicle part 300 may comprise a composite laminate 330, having a particle impregnated prepreg layer 320 and a coating 310.

As shown in the example embodiment, the particle impregnated prepreg layer 320 mates to an outer surface of the composite laminate 330. The particle impregnated prepreg layer 320 may serve as an attachment, bonding, or anchoring point for the coating 310. The particle impregnated prepreg layer 320 may promote adhesion of the coating 310 and thus mitigate or prevent premature bond failures of the coating 310 on the vehicle part 300.

The particle impregnated prepreg layer 320 may comprise a fiber and a resin matrix sheet wherein the fiber is pre-impregnated with the resin matrix. The fibers in the particle impregnated prepreg layer 320 may be of any suitable material, such as aramid fiber, carbon fiber, glass, etc. The fiber weave of the particle impregnated prepreg layer 320 may be of any suitable weave. For example, the prepreg fiber design may be unidirectional, plain weave, 2×2 twill weave, 4×4 twill weave, 5 harness, 8 harness, etc. In some embodiments, however, the fiber of the particle impregnated prepreg layer 320 may comprise no weave pattern and/or discernable fiber orientation, and may be scattered in a random orientation.

Further the resin matrix may also be of any suitable composition, type, or structure; for example the resin may be a metal matrix or a thermoplastic/thermoset polymer matrix, such as epoxies. The resin/matrix of the particle impregnated prepreg layer 320 may further be impregnated or doped with particles. The particles may be metallic, ceramic, or metallic-ceramic. The particles may comprise varying alloys, sizes, shapes, and structures that are chosen based, at least partially, on adhesion/bond strength capabilities with the coating 310. The distribution and concentration of the particles may further be optimized based on adhesion/bond strength capabilities with the coating 310.

The coating 310 may have the same properties as coating 210 described above. In some embodiments, the particles of coating 310 may be of the same or similar material as at least one of the materials applied in the coating 210. The amount of particles included in the resin/matrix of the particle impregnated prepreg layer 320 may vary based on the needs of the design.

In some embodiments the fiber of the particle impregnated prepreg layer 320 may itself include a metallic and/or particle coating. For example, the particle impregnated prepreg layer 320 may employ a metallic coated fiber in addition to a metallic, ceramic, or metallic-ceramic impregnated resin/matrix. In other examples the particle impregnated prepreg layer 320 may use an un-impregnated resin/matrix with a metallic coated fiber. However, in other embodiments, the resin/matrix may be impregnated or doped with the particles while the fiber may not be coated with the particles. Yet in further embodiments, the particle impregnated prepreg layer 320 may have particles distributed across and/or pressed onto a surface, prior to curing; for example the surface that the coating 310 is subsequently applied. Thus, the particles may be present on both the fiber as a coating and dispersed in the matrix, solely on the fiber as a coating, solely dispersed within the matrix, or dispersed along a surface.

Once the particle impregnated prepreg layer 320 has been cured, the distributed and/or pressed surface particles may serve as attachment or bonding points for the coating 310, and may promote additional bond strength between the coating 310 and the particle impregnated prepreg layer 320. The particles chosen for surface distribution may be similar to those described with respect to other embodiments disclosed herein.

As previously stated, the particle impregnated prepreg layer 320 may serve as an attachment, anchor, and/or bonding promoter for the coating 310; the increased attachment capabilities may allow for a reduced temperature and/or velocity to be used in the process for applying, for example thermal spraying, the coating 310. The particle impregnated prepreg layer 320 may comprise a single ply or a plurality of plies. The thickness of the particle impregnated prepreg layer 320 is based, at least partially on, the number of plies used and the respective thickness of each ply.

Surface preparation of the vehicle part 300 may be performed before and/or after any step in the process. For example, prior to application of the particle impregnated prepreg layer 320, the composite laminate 330 may undergo a surface treatment, such as abrading, to increase bond strength and adhesion of the particle impregnated prepreg layer 320. Similarly, prior to application of the coating 310, the particle impregnated prepreg layer 320 may undergo surface treatment, such as abrading, to promote adhesion and increase bonding strength of the coating 310.

Abrading may be performed by techniques known to those having ordinary skill in the art. For example, emery cloth or grit blasting may be used. The abrading of the particle impregnated prepreg layer 320 may create more attachment points for the particles in the coating 310 to anchor or attach, which may result in requiring lower coating temperatures and velocities as would otherwise be traditionally required. This may protect the composite laminate 330 structural properties from thermal damage during coating. The techniques contemplated in these paragraphs with respect to the vehicle part 300 are similarly applicable to the vehicle part 200.

In some embodiments, the particle impregnated prepreg layer 320 may further be included as a structural feature and help transfer loading throughout the vehicle part 300, while in other embodiments the particle impregnated prepreg layer 320 does not significantly contribute to overall load carrying capabilities.

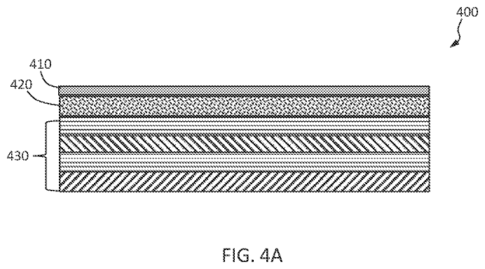

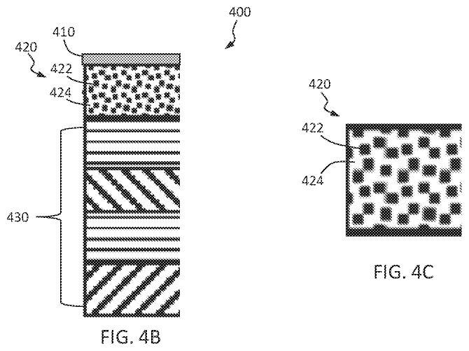

FIG. 4A is a cross-sectional view of a vehicle part 400, including a particle embedded surface, according to an example embodiment of the present invention. As illustrated, the vehicle part 400 may comprise a composite laminate 430, having a particle embedded surface 420 and a coating 410 disposed on an outer surface of the particle embedded surface 420. While FIG. 4A illustrates the particle embedded surface 420 situated above the composite laminate 430, it is to be understood that the particle embedded surface 420 may be located on any surface of the composite laminate 430.

For example, in rotor blades having a cross-sectional airfoil shape, the particle embedded surface 420 may be located on a leading edge, a trailing edge, an upper camber (upper surface), and/or a lower camber (lower surface). The particle embedded surface 420 may cover the entire outer surface area of the composite laminate 430, or it may only cover a portion of the outer surface area of the composite laminate 430. For example, the amount of surface area of the composite laminate 430 covered by the particle embedded surface 420 may range between 1-20%, 20-50%, 50-75%, or 75-100% of the total surface area. Further, the particle embedded surface 420 may be located along select portions of the composite laminate 430. For example, in a composite laminate rotor blade the particle embedded surface 420 may cover the leading edge and the first 25 percent chord length of the upper surface.

The particle embedded surface 420 may span the longitudinal length of the composite laminate 430, for example from root to tip of the rotor blade. However, in other examples the particle embedded surface 420 may lie along only a portion of the longitudinal length of the composite laminate 430. The composite laminate 430 may comprise the same or similar structure, material, and other aspects as the composite laminate 230 and/or 330 described above. Curing of the particle embedded surface 420 may be performed in the same or similar ways as described above with respect to FIGS. 2 and 3, or by techniques known now or in the future to those having ordinary skill in the art.

FIGS. 4B and 4C show an exploded cross-sectional view of the example embodiment of FIG. 4A. As shown, the particle embedded surface 420 comprises a plurality of particles 422 and a resin 424. The resin 424 may be impregnated with the particles 422, and the particles 422 may be dispersed throughout the resin 424. The particles 422 may be mixed into the resin 424 prior to application onto the composite laminate 430 so that the dispersion of the particles within the resin 424 is random and/or relatively uniform. In this example, the concentration of the particles 422 in the resin 424 produces sufficient anchoring/bonding points to promote better adhesion of the coating 410.

In some examples, the resin 424 may be a thermoplastic or a thermoset based resin. In examples where the resin 424 is a thermoplastic based resin, the thermoplastic based resin may be impregnated with the particles 422 during an upstream manufacturing process. In such examples, the particle impregnated thermoplastic based resin may come in the form of solid pellets. The solid pellets may be heated until a liquid stage is reached at which point the particle impregnated thermoplastic based resin may be suitable for application as the particle embedded surface 420. For example, a particle impregnated thermoplastic based resin sheet may be formed for subsequent use as the particle embedded surface 420. At least one particle impregnated thermoplastic based resin sheet may serve as a ply layer, such as a surface ply, during layup of the vehicle part 400, such that the particle embedded surface 420 may be co-cured with the vehicle part 400.

Prior to application of the particle embedded surface 420, surface preparation of the composite laminate 430 may be performed to increase adhesion and bond strength of the particle embedded surface 420. For example, the composite laminate 430 may have the surface lightly abraded, such as by grit blasting or emery cloth, to increase attachment points. The particle impregnated resin may then be applied, for example as a surfacing film, to a surface of an existing composite laminate 430 of the vehicle part 400. The particle embedded surface 420 may then be cured onto the composite laminate 430, and once cured, the coating 410 may be applied.

Alternatively, after curing of the particle embedded surface 420, and prior to application of coating 410, surface preparation may be performed to the particle embedded surface 420 to increase adhesion and bond strength of the coating 410. For example, the cured surface of the particle embedded surface 420 may be abraded to increase surface roughness and receptiveness of the particles 422 to the coating 410.

In other embodiments, the resin 424 may be applied to the composite laminate 430 prior to receiving the particles 422, and the particles 422 may then be applied to, or interspersed along, the surface of the resin 424 prior to curing. The particle embedded surface 420 may then be cured. Subsequently, the coating 410 may be applied to the particle embedded surface 420, with or without surface preparation. In such an example, a higher concentration of the particles 422 may be present on the surface of the particle embedded surface 420 that receives the coating 410. This may increase bonding strength and/or adhesion of the coating 410 to the particle embedded surface 420 and consequently to vehicle part 400.

In a further embodiment, the particle embedded surface 420 may be created during manufacturing of the composite laminate 430, such as during layup. In this example, the particles 422 may be at least partially embedded onto select areas of the surface ply or plies during layup and cured onto composite laminate 430. The particles 422 may also be dispersed along a tool or mold used in the manufacturing process of the composite laminate 430 such that during layup, the surface ply or plies are in contact with the dispersed particles along the tool and are cured onto the surface of the composite laminate 430. The embodiments disclosed in this paragraph result in the particle embedded surface 420 being co-cured with a surface ply or plies of the composite laminate 430, such that there may be no discernable layer distinction between the two layers. The coating 410 may then be applied to the particle embedded surface 420 using the methods, techniques, and processes previously discussed with respect to other embodiments. The coating 410 may have the same properties as coatings 210 and 310 described above.

With respect to FIGS. 4A, 4B, and 4C, the particles 422 chosen for the particle embedded surface 420 may comprise varying materials, sizes, shapes, and structures that are chosen based, at least partially, on adhesion/bond strength capabilities with coating 410. For example, the particles 422 may comprise similar particles to the coating 410 to be applied. The particles 422 may comprise the same or similar particles to those disclosed with respect to FIGS. 2 and 3.

Further, the concentration and distribution of the particles 422 to the resin 424 may vary based, at least on, on the parameters of the coating 410 to be applied. For example, the particles 422 may include a range of sizes, such as 0-20 μm, 15-45 μm, 40-55 μm, 50-100 μm, 100-150 μm, or a ratio between size ranges to achieve a desired D10, D50, & D90 particle size distribution characteristic. Further the concentration of the particles 422 in the particle embedded surface 420 may be 0.1-20 percent, 20-40 percent, 25-50 percent, and 30-60 percent by weight of the total concentration applied to the rotor surface prior to curing. The dispersion of the particles 422 may be substantially uniform throughout the cross-sectional area of the particle embedded surface 420, or a higher concentration of the particles 422 may be present along the surface of the particle embedded surface 420 that receives the coating 410. For example, at least 60 percent, 70 percent, 80 percent, or 90 percent of the particles 422 by weight of the total concentration applied to the rotor surface may be dispersed along the surface or within an appreciable distance from the surface to which the coating 410 is applied.

The resin 424 may be the same or a similar matrix used in the manufacturing of composite laminate 430 to bond strength of the particle embedded surface 420 on the composite laminate 430. However, other another matrix may be chosen based on desirable characteristics. The type, characteristic, and property of resin 424 may include all aspects of the resin and matrix discussed with respect to FIGS. 2 and 3.

In some embodiments the cross-sectional thickness of the particle embedded surface 420 may be between 0-500 μm. However, in other embodiments the cross-sectional thickness may be between 500-1000 μm, 1000-1500 μm, 1500-2000 μm, or greater than 2000 μm. As previously stated with other embodiments, the cross-sectional thickness may vary along a cross-section of the vehicle part 400. For example in the cross-section of a rotor blade, the particle embedded surface 420 may have a thicker cross section along the leading edge and may have no cross-sectional thickness along the trailing edge, indicating that the particle embedded surface 420 was not applied to the entire surface area of the rotor blade.

The various embodiments of the coated fiber layer 220, the particle impregnated prepreg layer 320, and the particle embedded surface 420 may increase adhesion and bond strength of the coating 210, 310, and 410, respectively, by increasing the number of attachment points that the particles of the coating 210, 310, and 410 anchor to during application. Having the same or similar particles or material to the coating included in the coated fiber layer 220, the particle impregnated prepreg layer 320, and the particle embedded surface 420 may create a similar structure for the molten material of the coating to attach. The similar properties between the particles and/or material may act similar to a seed particle, or seed crystal, that allows the molten material forming the coating to affix and solidify, which in turn allows more molten particles to affix to this anchor and form a layer. Having many thousands of seed particles may create many thousands of attachment points for the molten material forming the coating to bond. As the molten material is continually applied the layer may grow along the surface of the coated fiber layer 220, the particle impregnated prepreg layer 320, and the particle embedded surface 420 and form a strong interconnected web of coating material bonded to the particles within the embodiments. Continued application of the molten material may grow the base layer until the desired surface is sufficiently coated and reaches an optimum coating thickness.

Without such anchoring points, the coating may not properly bond due to dissimilar material properties, and as a result the coating may prematurely fail. Or to create such anchoring points without the coated fiber layer 220, the particle impregnated prepreg layer 320, and the particle embedded surface 420, one may be forced to apply the coating at an increased energy level, higher temperatures and velocities, which may damage the structural properties of the material.

Thermoplastic and/or thermoset matrices may be used in of any of the embodiments described in FIGS. 2 through 4C. For example, the thermoplastic and/or thermoset matrix may be used as the matrix for the layers 220, 320, and/or 420. In some examples, the thermoplastic matrix may be a thermoplastic film. The thermoplastic film may take the form of a sheet of thermoplastic material. In some examples, the thermoplastic film may be mated to a surface of a prepreg, such as to an outer surface of a thermoplastic prepreg, while in other examples the thermoplastic film may be mated to a fiber cloth. Heat and/or pressure (e.g., hot pressing) may be applied to the thermoplastic film to increase plasticity of the resin and encourage coupling between the film and the prepreg or fiber cloth. For example, the thermoplastic film may be hot pressed onto a surface of the Veelo VEIL™M In other examples, a plurality of thermoplastic films may be used. For example, the prepreg or the fiber cloth may be disposed between two or more layers of thermoplastic film then hot pressed to couple the respective parts.

The thermoplastic film may be impregnated with the previously described particles such that the particles are randomly and/or evenly distributed throughout the thermoplastic film. In other examples, however, the particles may be applied to a surface of the thermoplastic film such that upon curing (e.g., applying heat and/or pressure) the particles may become integrated with the thermoplastic film.

Particle impregnated thermoplastic plies may allow for integration onto the vehicle part during the manufacturing process. For example, at least one particle impregnated thermoplastic laminate ply may serve as a ply during layup of the vehicle part. The entire stackup of plies may be cured together (e.g., co-cured) which may reduce a likelihood of structural properties becoming adversely affected.

One or more of the examples described with respect to FIGS. 1 through 4C may be combinable with each other. For example, a thermoplastic matrix based vehicle part may include a thermoset based particle layer. In such examples, the thermoset matrix and/or a fiber disposed within the thermoset matrix (e.g., a cloth or prepreg ply) may be impregnated and/or coated with the particles. In some examples, the thermoset matrix vehicle part may be cured in a first step and the thermoset based particle layer may be coupled to the vehicle part in a second step. For example, the rotor blade 100 (FIG. 1) may be made from the thermoplastic laminate and subsequently coupled with the particle embedded surface 420 (FIG. 4A) using a thermoset as the resin 424. The thermoplastic matrix may provide desirable structural and/or manufacturing properties for the rotor blade 100, while the thermoset matrix may provide desirable particle dispersion properties as a seed layer for particle deposition. Thus, aspects of a first example may be combinable with aspects on another example to allow for optimization of the vehicle part.

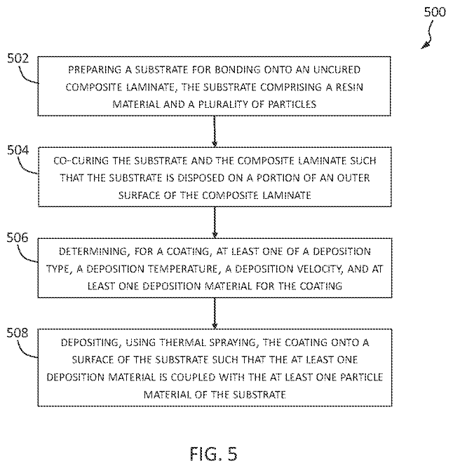

FIG. 5 is a block diagram illustrating a method 500 for bonding a coating onto a composite laminate structure, according to an example embodiment of the present invention. The method 500 may include one or more operations, or actions as illustrated by one or more steps 502-508. Although the steps are illustrated in a sequential order, these steps may in some instances be performed in parallel, and/or in a different order than those described herein. Also, the various blocks may be combined into fewer steps, divided into additional steps, and/or removed based upon the desired implementation.

As illustrated, at step 502, the method 500 may include preparing a substrate for bonding onto an uncured composite laminate. The substrate may comprise a resin material and a plurality of particles, where the plurality of particles form anchoring points for deposition of a coating.

At step 504, the method 500 may include co-curing the substrate and the composite laminate such that the substrate is disposed on a portion of an outer surface of the composite laminate.

At step 506, the method 500 may include determining, for a coating, at least one of a deposition type, a deposition temperature, a deposition velocity, and at least one deposition material for the coating.

At step 508, the method 500 may include depositing, using thermal spraying, the coating onto a surface of the substrate such that the at least one deposition material is coupled with the at least one particle material of the substrate.

In some examples, preparing the substrate for bonding onto the uncured composite laminate may further include determining an amount and a type of at least one of a resin material, a fiber material, and at least one particle material. In such examples, when determining the resin material the determination is based on a material property of a resin material used in the composite laminate, and where when determining the at least one particle material, the determination is based on bonding properties of the at least one particle material with the at least one deposition material for the coating.

In some examples, preparing the substrate for bonding onto the uncured composite laminate may further include: distributing, randomly, the plurality of particles throughout the resin to form a particle impregnated resin; impregnating the fiber material with the particle impregnated resin to form a particle impregnated ply; and engaging a surface of the particle impregnated ply with a surface of the uncured composite laminate.

In some examples, the substrate further includes a plurality of fibers. The fibers being coated with the plurality of particles to form particle coated fibers. In such examples, the particle coated fibers are impregnated with the resin material.

In some examples, the substrate is a particle impregnated prepreg fiber sheet, where the plurality of particles are coated onto the fiber.

In some examples, the substrate is a particle impregnated prepreg fiber sheet, where the plurality of particles are randomly distributed throughout the resin.

In some examples, the composite laminate structure is a rotor blade, and depositing the coating onto the surface of the substrate may include thermally spraying the coating between a 0 and 25 percent chord length from a leading edge of the rotor blade.

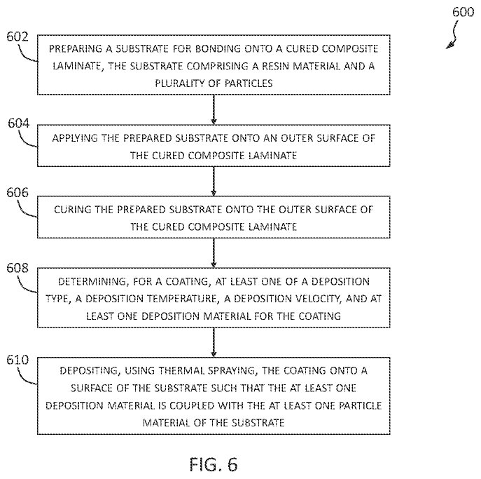

FIG. 6 is a block diagram illustrating another method 600 for bonding a coating onto a composite laminate structure, according to an example embodiment of the present invention. The method 600 may include one or more operations, or actions as illustrated by one or more steps 602-610. Although the steps are illustrated in a sequential order, these steps may in some instances be performed in parallel, and/or in a different order than those described herein. Also, the various blocks may be combined into fewer steps, divided into additional steps, and/or removed based upon the desired implementation.

As illustrated, at step 602, the method 600 may include preparing a substrate for bonding onto a cured composite laminate. The substrate may include a resin material and a plurality of particles, where the plurality of particles form anchoring points for deposition of a coating.

At step 604, the method 600 may include applying the prepared substrate onto an outer surface of the cured composite laminate.

At step 606, the method 600 may include curing the prepared substrate onto the outer surface of the cured composite laminate.

At step 608, the method 600 may include determining, for a coating, at least one of a deposition type, a deposition temperature, a deposition velocity, and at least one deposition material for the coating.

At step 610, the method 600 may include depositing, using thermal spraying, the coating onto a surface of the substrate such that the at least one deposition material is coupled with the at least one particle material of the substrate.

In some examples, preparing the substrate for bonding onto the cured composite laminate may further include determining an amount and a type of at least one of a resin material, a fiber material, and at least one particle material. In such examples, when determining the at least one particle material, the determination is based on bonding properties of the at least one particle material with the at least one deposition material for the coating.

In some examples, preparing the substrate for bonding onto the cured composite laminate may further include distributing, randomly, the plurality of particles throughout the resin to form a particle impregnated resin; impregnating the fiber material with the particle impregnated resin to form a particle impregnated ply; and engaging a surface of the particle impregnated ply with a surface of the cured composite laminate.

In some examples, the substrate may further include a plurality of fibers. The fibers being coated with the plurality of particles to form particle coated fibers. In such examples, the particle coated fibers may be impregnated with the resin material.

In some examples, the substrate is a particle impregnated prepreg fiber sheet, where the plurality of particles are coated onto the fiber.

In some examples, the substrate is a particle impregnated prepreg fiber sheet, where the plurality of particles are randomly distributed throughout the resin.

In some examples, the composite laminate structure is a rotor blade, and depositing the coating onto the surface of the substrate may include thermally spraying the coating between a 0 and 25 percent chord length from a leading edge of the rotor blade.

The above detailed description describes various features and functions of the disclosed systems, apparatus, and methods with reference to the accompanying figures. In the figures, similar symbols typically identify similar components, unless context dictates otherwise.

The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

What is claimed is:

1. A vehicle part comprising:
a composite laminate;
a substrate coupled to an outer surface of the composite laminate; and
a coating, the coating being thermally applied to the substrate;
wherein the substrate promotes bonding between the thermally applied coating and the substrate.

2. The vehicle part of claim 1, wherein the substrate is a composite comprising:
a plurality of particles comprising at least one particle material, wherein the plurality of particles promote bonding between the thermally applied coating and the substrate;
a resin; and
a fiber impregnated with the resin.

3. The vehicle part of claim 2, wherein the fiber of the substrate is coated with the plurality of particles, and wherein the plurality of particles are disposed within the resin of the substrate.

4. (canceled)

5. The vehicle part of claim 2, wherein the fiber impregnated with resin is a first fiber and the composite laminate comprises a second fiber different than the first fiber.

6. The vehicle part of claim 1, wherein the substrate comprises:
a resin; and
a plurality of particles, the plurality of particles comprising at least one particle material, wherein the plurality of particles promote bonding between the thermally applied coating and the substrate.

7. The vehicle part of claim 6, wherein the plurality of particles are randomly disposed throughout the resin, or wherein at least 50% of the plurality of particles are disposed on a surface of the substrate that includes the thermally applied coating.

8. (canceled)

9. The vehicle part of claim 2, wherein the resin is a thermoplastic or a thermoset.

10. (canceled)

11. The vehicle part of claim 2, wherein a type of resin used in the composite laminate is the same as the resin of the substrate.

12. The vehicle part of claim 2, wherein the substrate is co-cured with the composite laminate and forms an outer ply along a portion of the composite laminate.

13. The vehicle part of claim 2, wherein the plurality of particles comprise a first particle material and a second particle material different than the first particle material.

14. The vehicle part of claim 2, wherein a particle material of the coating is the same as the at least one particle material of the plurality of particles of the substrate.

15. The vehicle part of claim 2, wherein the coating is thermally coupled to at least one of the plurality of particles of the substrate.

16. The vehicle part of claim 1, wherein the vehicle part is a rotor blade, and wherein the coating is thermally applied between a 0 and 25 percent chord length from a leading edge of the rotor blade.

17. (canceled)

18. A method for bonding a coating onto a composite laminate structure, the method comprising:
preparing a substrate for bonding onto an uncured composite laminate, the substrate comprising a resin material and a plurality of particles, wherein the plurality of particles form anchoring points for deposition of a coating;
co-curing the substrate and the composite laminate such that the substrate is disposed on a portion of an outer surface of the composite laminate;
determining, for a coating, at least one of a deposition type, a deposition temperature, a deposition velocity, and at least one deposition material for the coating; and
depositing, using thermal spraying, the coating onto a surface of the substrate such that the at least one deposition material is coupled with at least one particle material of the substrate.

19. The method of claim 18, wherein preparing the substrate for bonding onto the uncured composite laminate further comprises:
determining an amount and a type of at least one of a resin material, a fiber material, and at least one particle material,
wherein when determining the resin material the determination is based on a material property of a resin material used in the composite laminate, and wherein when determining the at least one particle material, the determination is based on bonding properties of the at least one particle material with the at least one deposition material for the coating.

20. The method of claim 18, wherein preparing the substrate for bonding onto the uncured composite laminate further comprises:
distributing, randomly, the plurality of particles throughout the resin material to form a particle impregnated resin;
impregnating a fiber material with the particle impregnated resin to form a particle impregnated ply; and
engaging a surface of the particle impregnated ply with a surface of the uncured composite laminate.

21. The method of claim 18, wherein the substrate further comprises a plurality of fibers, the fibers being coated with the plurality of particles to form particle coated fibers, and wherein the particle coated fibers are impregnated with the resin material.

22. (canceled)

23. The method of claim 18, wherein the substrate is a particle impregnated prepreg fiber sheet, wherein the plurality of particles are coated onto the fiber, or wherein the plurality of particles are randomly distributed throughout the resin material.

24. (canceled)

25. The method of claim 18, wherein the composite laminate structure is a rotor blade, and depositing the coating onto the surface of the substrate comprises:
thermally spraying the coating between a 0 and 25 percent chord length from a leading edge of the rotor blade.

26. A method for bonding a coating onto a composite laminate structure, the method comprising:
preparing a substrate for bonding onto a cured composite laminate, the substrate comprising a resin material and a plurality of particles, wherein the plurality of particles form anchoring points for deposition of a coating;
applying the prepared substrate onto an outer surface of the cured composite laminate;
curing the prepared substrate onto the outer surface of the cured composite laminate;
determining, for a coating, at least one of a deposition type, a deposition temperature, a deposition velocity, and at least one deposition material for the coating; and
depositing, using thermal spraying, the coating onto a surface of the substrate such that the at least one deposition material is coupled with the at least one particle material of the substrate.

27.-33. (canceled)
